(19) United States
(12) Patent Application Publication
(10) Pub. No.: US 2005/0277084 A1
(43) Pub. Date: Dec. 15, 2005

(54) Orthodontic brace with polymeric arch member

(75) Inventors: David K. Cinader, Yorba Linda, CA (US); James D. Cleary, Glendora, CA (US); Richard E. Raby, North St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/865,649

(22) Filed: Jun. 10, 2004

(51) Int. Cl. A61C 3/00

(52) U.S. Cl. 433/20; 433/3; 433/24

(57) ABSTRACT

A brace for an orthodontic patient includes a polymeric arch member that is removably connected to a series of appliances that are affixed to the patient's teeth. The arch member is preferably made of an aesthetic polymeric material that transmits light and has shape memory properties. Optionally, a sequential set of arch members may be provided to move the teeth in incremental steps toward desired final positions.

### BACKGROUND OF THE INVENTION

1. Field of the Invention

This invention relates to a brace used in the course of orthodontic treatment. More particularly, the present invention relates to an orthodontic brace having a polymeric arch member.

2. Description of the Related Art

Orthodontic treatment involves movement of a dental patient's teeth to improved positions in proper alignment with each other. Orthodontic treatment can greatly enhance the patient's facial appearance, especially in regions near the front of the oral cavity. Orthodontic treatment can also improve the function of the teeth so that the opposing teeth work better with each other during mastication.

One type of common orthodontic treatment includes the use of a set of tiny appliances known as brackets. Each bracket has a slot and is affixed to one of the patient's anterior, cuspid or bicuspid teeth. Conventionally, a thin, resilient metallic archwire is received in the slots of the brackets and forms a track to guide movement of the teeth to desired positions. Ends of the archwire are often received in buccal tube appliances that are affixed to the patient's molar teeth.

Another type of common orthodontic treatment system involves a series of custom-made plastic positioning shells or trays such as the “Invisalign” brand trays sold by Align Technology of Santa Clara, Calif. Each tray fits over the sides and outer tips of the teeth and is made to move the teeth a relatively small, incremental distance toward desired final positions. The trays are made of a plastic material with sufficient resiliency to urge the teeth toward positions defined by the tray when the tray is relaxed.

Regardless of which orthodontic treatment system is employed, it is often desirable to manufacture the components of the system from a material that is aesthetically pleasing so that the patient's facial appearance is not unduly affected during the course of treatment. For example, components of the treatment system may be made of a transparent or translucent material that enables the color of the patient's teeth to be visible through the selected components. As another alternative, the components may be made of a material that has a color that matches the color of the patient's dentition.

### SUMMARY OF THE INVENTION

The present invention is directed toward an orthodontic brace having a polymeric arch member. The arch member is removably coupled to a set of appliances that are affixed to respective teeth of a patient's dental arch. The arch member need not be removed during eating, and yet may be readily replaced by the orthodontic practitioner when desired. Preferably, the polymeric arch member can be made of an aesthetically pleasing translucent or transparent material so that the natural color of the patient's dentition is visible.

In more detail, the present invention is directed in one aspect to a brace for an orthodontic patient. The brace comprises a set of orthodontic appliances for connection to respective teeth of a patient's dental arch. The brace also comprises an elongated arch member that is removably coupled to at least some of the appliances. The arch member comprises a polymeric material that can be changed from a first state that facilitates removal or installation of the arch member to a second state that facilitates orthodontic treatment.

The use of the polymeric material described above is an advantage, in that the arch member can be constructed to provide additional tooth-moving forces when needed for use. For example, the arch member may have a certain first shape at room or ambient temperature that facilitates coupling of the arch member to the appliances without undue effort or pressure on the patient's teeth. For instance, the arch member may be made of a shape memory polymeric material having glass transition temperature in the range between room or ambient temperature and normal body temperature. At temperatures above its glass transition temperature, the arch member tends to assume a certain second shape that is different than its shape below its glass transition temperature. The second shape is selected to provide additional force on the appliance and consequently on the corresponding teeth, for facilitating movement of the teeth to desired positions once the temperature of the installed arch member has reached a temperature similar to normal body temperature.

The present invention is also directed in another aspect to an orthodontic treatment system. The treatment system includes a set of orthodontic appliances for connection to respective teeth of a patient's dental arch. The system also comprises a set of elongated arch members adapted for removably coupling to at least some of the appliances. At least one arch member has a geometry selected to move the teeth from a first arrangement to a second arrangement, and at least one other arch member has a geometry selected to move the teeth from a second arrangement to a third arrangement.

Another aspect of the invention is directed toward a brace for an orthodontic patient. In this aspect, the brace comprises a set of orthodontic appliances for connection to respective teeth of the patient's dental arch. The brace also comprises an elongated arch member having a number of receptacles, wherein each receptacle receives a corresponding appliance. The arch member comprises a first component of a first polymeric material and a second component of a second polymeric material, wherein the first component is connected to the second component. The first component is remote from the receptacles and the second component is adjacent at least one receptacle. The first polymeric material has a rigidity that is greater than the rigidity of the second polymeric material.

Another aspect of the present invention is also directed to a brace for an orthodontic patient that comprises a set of orthodontic appliances. Each appliance is connected to a tooth of the patient's dental arch. The brace also comprises an elongated arch member having a number of receptacles, and each receptacle receives a corresponding appliance. At least one receptacle is elongated in a direction generally parallel to the longitudinal axis of the arch member in order to permit limited relative sliding movement of the appliance and the arch member.

These and other features of the invention are described in more detail in the paragraphs that follow and are illustrated in the accompanying drawings.

### BRIEF DESCRIPTION OF THE DRAWINGS

FIG. 1 is a side elevational view of a portion of an exemplary dental arch of an orthodontic patient that is undergoing treatment, wherein an orthodontic brace comprising a set of appliances and an arch member according to one embodiment of the invention has been connected to respective teeth of the dental arch;

FIG. 2 is a view somewhat similar to FIG. 1 except that the arch member of the brace has been removed;

FIG. 3 is an enlarged front elevational view of one of the appliances shown in FIGS. 1 and 2;

FIG. 4 is an enlarged side elevational view of the appliance alone shown in FIG. 3;

FIG. 5 is an enlarged cross-sectional view taken across the arch member and one of the appliances shown in FIG. 1, illustrating the releasable connection between the arch member and the appliance;

FIG. 6 is a view somewhat similar to FIG. 5 except showing an arch member constructed in accordance with another embodiment of the invention;

FIG. 7 is an enlarged view somewhat similar to FIG. 6 except showing an arch member constructed in accordance with yet another embodiment of the invention, and wherein the appliance and the adjacent tooth are not illustrated;

FIG. 8 is a view somewhat similar to FIG. 1 except showing an arch member constructed in accordance with still another embodiment of the invention;

FIG. 9 is a plan view showing an exemplary model of a patient's dental arch, wherein model teeth of the arch have been oriented and positioned in desired intermediate or final orientations or positions and a set of appliances have been mounted on the model teeth for making a brace according to one method of the present invention;

FIG. 10 is a view somewhat similar to FIG. 9 except that a sheet of elastomeric material has been formed over appliances mounted on the model teeth;

FIG. 11 is a view somewhat similar to FIG. 10 except that the sheet of elastomeric material has been cut in certain areas and a sheet of relatively rigid material has been formed over the sheet of elastomeric material; and

FIG. 12 is a plan view of a completed arch member of an orthodontic brace made using the method shown in FIGS. 9-11.

### DETAILED DESCRIPTION OF THE PREFERRED EMBODIMENTS

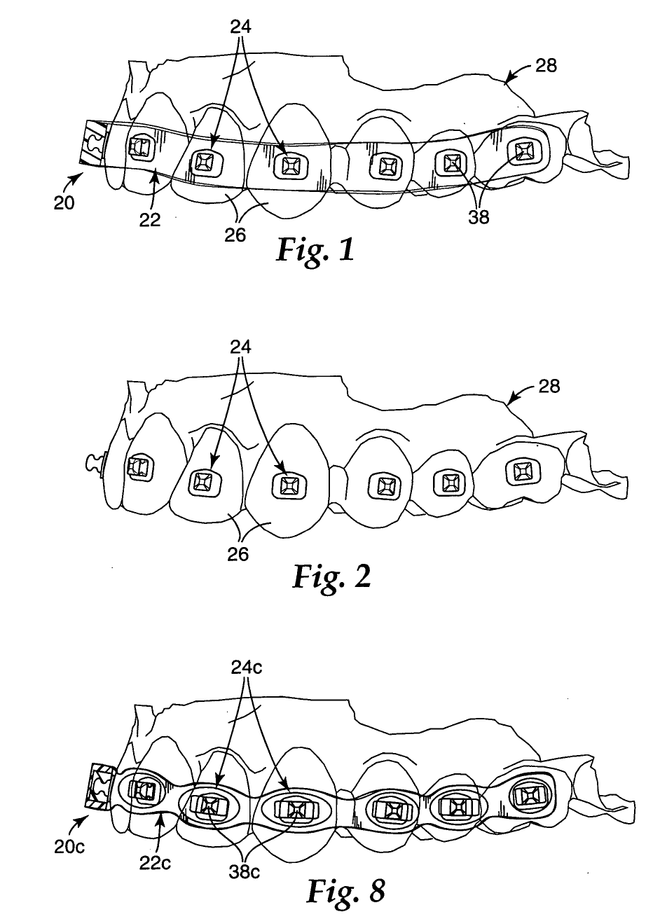

An orthodontic brace constructed according to one embodiment of the present invention is illustrated in FIG. 1 and is broadly designated by the numeral 20. The brace 20 includes an arch member 22 and a set of orthodontic appliances 24. The appliances 24 are each affixed to a respective tooth 26 of an orthodontic patient's dental arch 28. In FIG. 1, the illustrated dental arch 28 is an exemplary maxillary or upper dental arch, although it should be understood in this regard that the brace 20 may be adapted for use with the mandibular or lower dental arch as well.

FIG. 2 is an illustration somewhat similar to FIG. 1, except that the arch member 22 has been removed. As depicted, the appliances 24 are directly bonded to the enamel surface of the patient's teeth 26. Preferably, each tooth 26 of the dental arch 28 receives an appliance 24, although alternative arrangements are also possible. For example, the appliances 24 may be attached to all of the teeth 26 in the dental arch 28 except for the molar teeth, or may be attached to only certain selected teeth as may be desired by the practitioner.

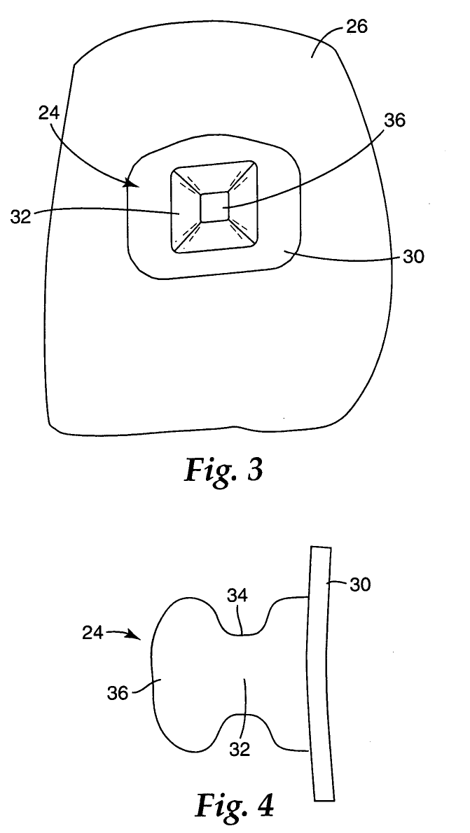

FIG. 3 is a front elevational view of an exemplary one of the appliances 24 as it might appear when affixed to tooth 26. FIG. 4 is a side elevational view of the appliance 24 alone. As shown, the appliance 24 includes a base 30 having an external surface that is adapted to be directly bonded to the enamel surface of the patient's tooth 26 by an adhesive. Optionally, the external surface of the base 30 has a compound concave contour that precisely matches the convex compound contour of a particular tooth. Optionally, the base 30 is provided with means for enhancing the bond between the appliance 24 and the selected adhesive, such as a roughened or dimpled surface, a surface having particles (irregularly-shaped or regularly-shaped) fixed to the base 30, structure for providing a mechanical interlock with the adhesive when hardened, chemical bond-enhancing means or any combination of the foregoing.

The appliance 24 includes a body 32 that is connected to the base 30. The body 32 has a neck portion 34 (FIG. 4) that presents an undercut region. The body 32 also includes a bulbous outer head 36 that is connected to the neck 34.

Preferably, the appliance 24 is made as a single, unitary component such that the body 32 is integrally connected to the base 30. Preferably, the appliance 24 is integrally made of an aesthetic material such as a material that is translucent or transparent to light in the visible wavelengths. As another option, the appliance 24 has a color that matches the color of the patient's adjacent dentition. If the appliance 24 is made of a transparent or translucent material, the material preferably transmits sufficient light to enable the color of the patient's underlying tooth to be visible through the front or labial side of the appliance 24.

Examples of suitable materials for constructing the appliance 24 include ceramic materials, such as single crystal alumina and polycrystalline alumina. Alternatively, the appliance 24 may be made of a polymeric material such as polycarbonate. Optionally, the polymeric material is reinforced with glass fibers. Suitable ceramic materials are described, for example, in U.S. Pat. Nos. 4,954,080 and 6,648,638. Suitable polymeric materials are described, for example, in U.S. Pat. No. 5,445,770.

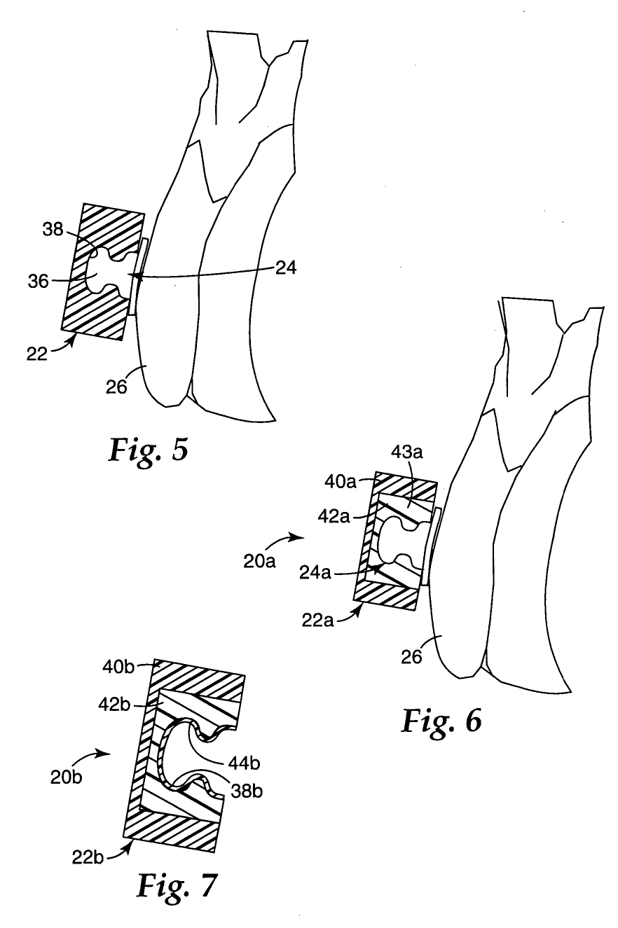

The arch member 22 includes a series of receptacles 38 (FIG. 5) that are spaced apart from each other along the length of the arch member 22. As depicted in FIG. 1, each of the receptacles 38 receives the head 36 of a respective appliance 24. Each of the receptacles 38 has a configuration adapted to releasably receive the head 36 in snap-fit relation. Consequently, the arch member 22 can be disconnected from the appliances 24 when desired.

The exemplary receptacles 38 shown in FIG. 1 surround the head 36 of each appliance 24 along the buccolabial, occlusal, mesial, gingival and distal sides of each head 36. However, other constructions are also possible. For example, the receptacles 38 may extend completely through the arch member 22 such that the receptacles 38 comprise apertures and buccolabial sides of the heads 36 are exposed when viewing the brace 20 in a lingual direction.

The arch member 22 illustrated in FIG. 1 is shown in enlarged cross-sectional view in FIG. 5. In this embodiment, the arch member 22 is made of a single layer of polymeric material having sufficient resiliency to receive the appliances 24 in snap-fit relation. To this end, the polymeric material deforms to enlarge the opening of the receptacle 38 as the arch member 22 is urged in a lingual direction in order to receive the head 36 of the respective appliance 24.

The arch member 22 is made of an aesthetically pleasing material such as translucent, transparent or tooth-colored polymeric materials. If the arch member 22 is made of a translucent or transparent material, the material preferably transmits sufficient light to enable the color of the patient's underlying dentition to be visible through the front or labial side of the arch member 22. Optionally, reinforcing fibers such as glass fibers can be embedded in the polymeric material of the arch member 22.

Preferably, the arch member 22 is capable of changing from a first state that facilitates removal and/or installation of the arch member 22 to a second state that facilitates orthodontic treatment. The change in state may comprise, for example, a change in material property or a change in shape, and is preferably induced by an environmental change that can be carried out in the patient's oral cavity. The change in state may occur throughout the arch member 22 or only in selected portions of the arch member 22.

As one example, the arch member 22 may comprise a shape memory polymer such as “Calo•MER” from Polymeric Technical Group, elastic memory composite (“EMC”) from Composite Technology Development, Inc. or “Veriflex” from Cornerstone Research Group. These materials have both a high and a low temperature transition. For instance, the polymeric material may have a lower glass transition temperature that is in the range of about 23° C. to about 37° C., and more preferably in the range of about 25° C. to about 35° C., and a higher transition temperature that is in the range of about 40° C. to about 50° C. The arch member 22 is shaped to conform to a model of the patient's teeth in desired positions at a temperature above the higher transition temperature, and then held in that shape as it is cooled to a temperature below its higher transition temperature. Next, the arch member 22 is shaped to conform to a model of the patient's teeth in current conditions at a temperature that is between the high and low transition temperature, and held in that shape while it is cooled to a temperature below the lower transition temperature. Such construction facilitates the initial connection of the arch member 22 to the appliances 24, such as in instances where the initial connection is carried out before the arch member 22 approaches body temperature. If the lower transition temperature is between room temperature and body temperature, the material will undergo a change in state once the arch member 22 is placed in the oral cavity and will subsequently provide forces for moving the teeth toward desired positions.

As another example, the arch member 22 may be made of a material that has a glass transition temperature above body temperature, and is shaped to provide for easy installation or removal at temperatures above its glass transition temperature. In this example, the arch member 22 is kept at a temperature below its transition temperature before installation. When it is desired to remove the arch member 22, it is warmed to a temperature above its glass transition temperature.

Alternatively, the arch member 22 may be constructed of homopolymers, cross-linked homopolymers and/or copolymer blends of thermoplastics with inherent memory as described in U.S. Pat. No. 6,183,248. Optionally, the material may have only a single transition temperature. To form the memory removal mechanism, these materials may be formed into a strip that loosely approximates the shape of the arch. Once formed into this arch shape, the strip is shaped at a temperature above its transition temperature such that it will deliver desired forces to the teeth, held in that shape and then cooled to a temperature below its transition temperature. Once the strip is in the mouth, heating the strip above the glass transition temperature will loosen it from the appliances. The change in state may also be carried out by methods other than a temperature change. For instance, the polymeric material may change its state when subjected to an aqueous buffer solution having a predetermined pH ratio. Alternatively, the change in state may occur when the polymeric material absorbs liquid as a result of a change in ionic strength. The change in state may be a change in shape such as expansion or shrinkage, and may also or in the alternative provide a change in material property such as rigidity (i.e. flexural rigidity) or durometer hardness.

The change in state may be selected to facilitate reception or disengagement of the heads 36 in the respective receptacles 38. For example, the change in state may provide an enlargement of the openings to the receptacles 38 when desired, so that less force is needed to insert the heads 36 in the receptacles. Once the insertion is complete, a reversal of the change in state contracts the openings in order to reduce the probability of unintentional detachment of the heads 36 from the arch member 22 during the course of treatment.

Other suitable polymeric materials that undergo a change in state are described in U.S. Pat. Nos. 6,183,248, 5,506,300 and 6,388,043, and U.S. Patent Application Publications Nos. U.S. 2003/0157454 and 2003/0055198, all of which are expressly incorporated by reference herein.

The arch member 22 may also be made of a multi-component material comprising multiple layers. As one example, some of the layers or components could undergo a change in state (such as a glass transition) to reduce the modulus of the arch member 22 for facilitating installation or removal of the arch member 22, while other layers or components remain rigid to help maintain the shape of the arch member 22. For instance, one layer may have a transition temperature of about 150° C. while a second layer may have a transition temperature of about 40° C. Additionally, one or more of the layers could vary in thickness in different regions along the length of the arch member 22. Examples of suitable multi-component materials are described in the above-mentioned U.S. Pat. No. 6,183,248.

As an additional option, an orthodontic treatment system may be provided that comprises the set of appliances 24 along with a series of arch members such as arch members similar to the arch member 22. The arch members are somewhat similar to each other, except that each arch member has a geometry that is selected to sequentially move the teeth in corresponding steps along an incremental treatment path.

For example, one of the arch members may have a geometry selected to move the teeth from an initial arrangement to a first intermediate arrangement. Another arch member may have a geometry selected to move the teeth from the first intermediate arrangement to a second intermediate arrangement. Additional arch members may also be provided as desired to move the teeth to other arrangements in sequence along the treatment path. Finally, a final arch member is provided and has a geometry selected to move the teeth from the last intermediate arrangement to the final desired arrangement generally corresponding to the desired arrangement of the teeth at the conclusion of treatment.

Preferably, the arch member 22 has a geometry when relaxed that generally corresponds to the geometry necessary to move the teeth to the desired intermediate or final positions. When the arch member 22 is placed on the appliances 24, however, the geometry of the arch member 22 is changed to a temporary shape corresponding to the shape of the tooth arrangement prior to reaching the desired intermediate or final arrangement, such as the current tooth arrangement. The resilient properties of the polymeric material function to exert forces on the teeth 26 as necessary to shift the teeth to the desired intermediate or final arrangement.

Preferably, the arch member 22 is connected to the appliances 24 such that the arch member 22 may exert forces on the appliances 24 and hence on the underlying teeth 26 in a number of different directions. For example, the arch member 22 can preferably exert forces as may be needed to move the appliances 24 in either or both translation and rotation with respect to three mutually perpendicular reference axes. As a result, the teeth 26 may be subjected to tipping, torquing or angulation movements as desired.

The releasable coupling between the arch member 22 and the appliances 24 in this embodiment comprises the heads 36 of the appliances 24 in combination with the receptacles 38 of the arch member 22. Both the receptacles 38 and the heads 36 have a configuration that permits effecting tooth movement along or about multiple axes as desired. To this end, the heads 36 and the receptacles 38 preferably have matching polygonal shapes, matching key and keyway shapes or other interlocking configurations that facilitate transmitting the desired forces from the arch member 22 to the appliances 24 and ultimately to the underlying teeth.

In addition to the arch member 22, or as an alternative, the appliances 24 may be made of a material that changes from a first state to a second state, wherein the first state facilitates coupling or uncoupling of the appliances 24 from the arch member 22 and the second state facilitate orthodontic treatment. For example, the appliances 24 may be made of a shape memory material as described above, and contracts in shape when cooled in order to ease insertion of the heads of the appliances 24 into the receptacles 38.

FIG. 6 illustrates an arch member 22a of an orthodontic brace 20a that is constructed in accordance with another embodiment of the invention. Except as described below, the arch member 22a is similar to the arch member 22 and accordingly a detailed description of the common elements need not be repeated.

The arch member 22a includes a first component 40a made of a first polymeric material and a second component 42a that comprises a spaced-apart series of cylindrical inserts 43a embedded in the first component 40a. Each of the cylindrical inserts 43a is made of a second polymeric material.

The cylindrical inserts 43a are spaced apart from each other a distance that matches the spacing between adjacent appliances. Each cylindrical insert 43a has a receptacle similar to receptacle 38 that receives the head of an appliance in snap-fit relation. Optionally, the thickness of the cylindrical inserts 43a in a buccolabial-lingual direction is the same as the thickness of the first component 40a such that the buccolabial and lingual sides of the cylindrical inserts 43a are flush with the buccolabial and lingual sides of the first component 40a respectively.

Other constructions are also possible. For example, the first component and the second component may resemble layers having equal lengths, with the second component having additional cylindrical portions received in spaced apart circular apertures of the first component in order to provide receptacles that fully surround the heads of the appliances. Moreover, the cylindrical portions may be replaced by portions having other shapes, such as an elliptical or ovoid cylinder, a bulbous shape matching the head of the appliances, a rectangular prism, etc.

Preferably, both of the components 40a, 42a are made of polymeric materials that undergo a change in state as described above. Additionally, the polymeric material of the first component 40a has a rigidity that is greater than the polymeric material of the second component 42a. As an example, the first component 40a may be made of a relatively rigid polycarbonate material, and the second component 42a may be made of a rubbery material such as medical grade silicone rubber.

The arch member 22a shown in FIG. 6 is an advantage in that the first component 40a has sufficient rigidity to facilitate moving the teeth to desired arrangements. By contrast, the polymeric material of the second component 42a is less rigid to facilitate attachment and removal of the arch member 22a from the appliances, such as the appliance 24a shown in FIG. 6. The flexible second component 42a readily deforms so that the arch member 22a can be coupled to the appliances 24a without undue effort or pressure on the patient's teeth.

FIG. 7 illustrates an arch member 22b of an orthodontic brace according to another embodiment of the invention. In FIG. 7, the appliances of the brace 20b are not shown but are preferably similar to the appliances 24, 24a described above.

The arch member 22b is somewhat similar to the arch member 22a, in that the arch member 22b includes a first component 40b made of a first polymeric material and a second component 42b made of a second polymeric material. However, the arch member 22b also includes a third component comprising a series of inserts 44b made of a third polymeric material.

The third polymeric material of the third component 44b has a rigidity that is greater than the rigidity of the second polymeric material of the second component 42b. The inserts 44b serve to distribute stresses imposed on the arch member 22b in a uniform manner so that the probability of relatively high localized stresses in areas adjacent the appliances is reduced. The inserts 44b also facilitate transfer of the force from the arch member 22b to the appliances so that more precise control may be provided over movement of the patient's teeth. Preferably, the inserts 44b are made of an aesthetic material such as the polymeric materials described above in connection with the arch member 22.

Preferably, each receptacle 38b of the arch member 22b is provided with an insert 44b for connection to a corresponding appliance. The inserts 44b partially surround the corresponding appliances. As an additional option, the inserts 44b may be integrally connected together in the form of an elongated strip that extends along all or at least a portion of the length of the components 40b, 42b.

An orthodontic brace 20c according to another embodiment of the invention is illustrated in FIG. 8. The brace 20c includes an arch member 22c and a set of appliances 24c. Except as described in the paragraphs that follow, the brace 20c is essentially identical to the brace 20a described in connection with FIG. 6.

The arch member 22c includes a spaced apart series of receptacles 38c, each of which receives a respective one of the appliances 24c of the brace 20c. However, the receptacles 38c have a longitudinal axis that extends generally parallel to the longitudinal axis of the arch member 22c. The receptacles 38c are somewhat wider than the overall width of the respective appliances 24c in directions generally along a mesial-distal reference axis, or along the longitudinal axis of the arch member 22c. As a result, the receptacles 38c permit limited relative sliding movement between the respective appliance 24c and the arch member 22c.

Preferably, the receptacles 38c, like the receptacles 38, include a cross-sectional shape that is similar to the shape of the heads of the appliances. Preferably, the receptacles 38c, like the receptacles 38, include an undercut region in order to provide an interlocking connection with the appliances 24c and to receive the appliances 24c in snap-fit relation. The elongated configuration of the receptacles 38c enables limited sliding movement between the appliance 24c and the arch member 22c as may be desired by the practitioner according to the treatment plan for the particular patient. Optionally, a biasing device such as a spring or resilient stop may be provided within the receptacles 38c and located at the mesial and/or distal ends of the receptacles 38c for engagement with the mesial or distal sides of the appliance 24c.

The orthodontic brace as described above in its various embodiments is advantageous for a number of reasons. For example, the arch member as well as the appliances may be made of an aesthetically pleasing material so that the brace is not readily visible in the mouth of the patient. Preferably, the material is resistant to staining by foods and beverages for the expected length of time that each article is used in treatment.

Another advantage of the present invention is that the patient may wear the brace 20 during eating, unlike most of the plastic positioners or trays conventionally available. The brace need not extend over the outer tips of the teeth and hence not contact the opposing teeth during mastication.

A number of alternative constructions are possible. For example, the arch member may have a cross-sectional configuration other than rectangular. Examples of such alternative shapes include elliptical, oval and square. Optionally, the cross-sectional shape of the arch member may vary along its length, and may be thicker in locations where additional forces are desired.

In addition, the appliances may have constructions other than that shown in the drawings. For example, the appliances may be conventional brackets, such as twin tiewing brackets and single tiewing brackets. Examples of suitable brackets are described, for example, in U.S. Pat. Nos. 5,439,379 and 6,582,226. Optionally, the arch member may be constructed by making a model of the patient's teeth, with appliances or mock appliances placed in appropriate locations on the teeth. A sheet of polymeric material may then be molded in a vacuum-forming process, using heat to shape the material to correspond to the shape of the model and the appliances. Subsequently, the molded material is cut into the shape of a strip to form the desired arch member.

If desired, two or more layers of polymeric material may be placed over the model in order to provide the multicomponent construction described above in connection with the embodiment shown in FIGS. 6-8. As an example, FIG. 9 is a top view of a physical model 60 of a patient's dental arch where the individual teeth 62 have been positioned and oriented to a desired future state according to a defined treatment plan. The model 60 is coated with a water-soluble release agent, and appliances (such as appliances 24) have been bonded to the model teeth 62. Preferably, the appliances 24 are bonded to the model teeth 62 using an adhesive that is suitable to form a custom base that precisely matches the contour of the respective tooth. The exposed surfaces of the appliances 24 are then coated with a release agent.

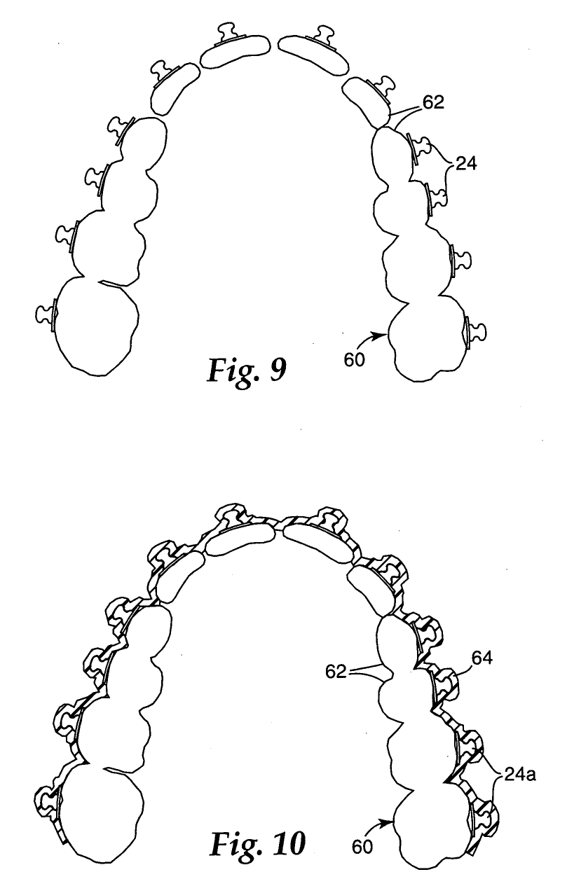

Next, and as shown in FIG. 10, a sheet of elastomeric material, such as Bioplast brand material (from Great Lakes Orthodontics, Ltd. of Tonawanda, N.Y.) or silicone rubber, is heated to a softened state and then vacuumed formed or pressure formed over the model teeth 62 and the appliances 24. The sheet 64 of elastomeric material is then allowed to cool.

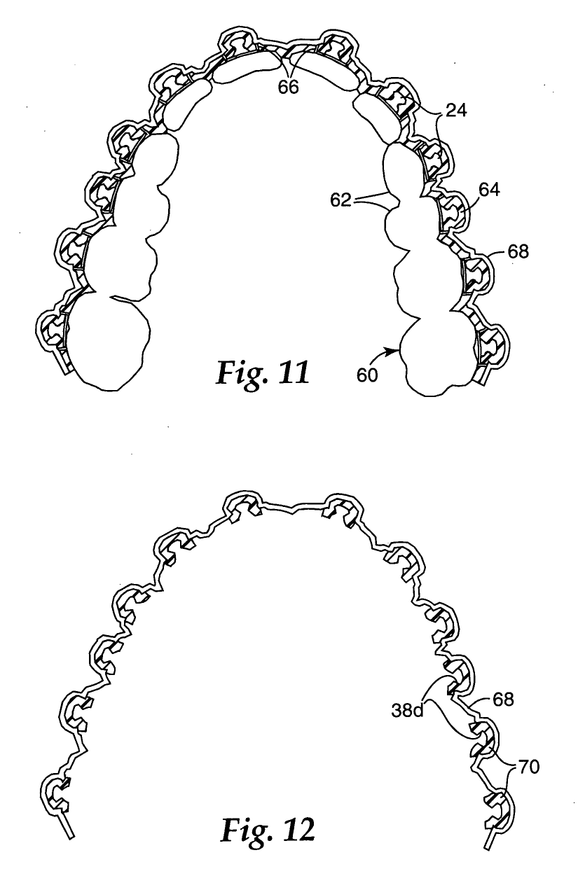

As illustrated in FIG. 11, the sheet 64 is then cut in areas surrounding the perimeter of the base of each appliance 24. Preferably, each section of elastomeric material between adjacent appliances is removed, coated with a silicone-based release agent on its labial side and replaced in its original position on the model 60. Exemplary cut lines are indicated by the numeral 66 in FIG. 11.

Subsequently, a sheet of rigid material 68, such as Biocryl brand material (from Great Lakes Orthodontics), polycarbonate or a shape memory polymer, is heated to a softened condition and then vacuumed or pressure formed over the elastomeric material 64. The rigid material 68 is then allowed to cool and assume the shape depicted in FIG. 11. Optionally, an adhesive may be used to bond the rigid material 68 to the elastomeric material 64 in areas adjacent the appliances 24. The adhesive may be applied to the material 64 during the time that the cut sections are removed as described above.

FIG. 12 is an illustration of the completed arch member. In this view, the sections of the unwanted elastomeric material between the cut lines 66 have been removed and the arch member is ready for application to appliances mounted on the patient's teeth. In FIG. 12, the inserts made using the sheet of elastomeric material 64 are designated by the numeral 70, and each insert 70 presents a receptacle (such as receptacle 38d) for receiving the head of an appliance mounted on the patient's teeth.

All of the patents and published patent applications identified herein are expressly incorporated by reference. Additionally, those skilled in the art will recognize that many modifications and alternative constructions may be made without departing from the essence of our invention. Accordingly, the invention should not be deemed limited to the specific embodiments described in detail above, but instead only by a fair scope of the claims that follow along with their equivalents.

1. A brace for an orthodontic patient comprising:
a set of orthodontic appliances for connection to respective teeth of the patient's dental arch; and
an elongated arch member removably coupled to at least some of the appliances, wherein the arch member comprises a polymeric material that can be changed from a first state that facilitates removal or installation of the arch member to a second state that facilitates orthodontic treatment.

2. A brace for an orthodontic patient according to claim 1 wherein the polymeric material comprises a shape memory material having a glass transition temperature that is in the range of about 23° to about 37° C.

3. A brace for an orthodontic patient according to claim 1 wherein the arch member has an overall shape that is adapted to move the teeth to predetermined, ideal positions.

4. A brace for an orthodontic patient according to claim 1 wherein the arch member transmits light.

5. A brace for an orthodontic patient according to claim 1 wherein the appliances transmit light.

6. A brace for an orthodontic patient according to claim 1 wherein the arch member includes a number of receptacles, and wherein each receptacle receives a corresponding appliance.

7. A brace for an orthodontic patient according to claim 6 wherein at least some of the receptacles are elongated in directions generally along the longitudinal axis of the arch member.

8. A brace for an orthodontic patient according to claim 1 wherein the arch member has a cross-sectional configuration in reference planes perpendicular to its longitudinal axis that varies along its length.

9. A brace for an orthodontic patient according to claim 8 wherein the cross-sectional configuration is generally elliptical or oval in at least one reference plane along the longitudinal axis.

10. A brace for an orthodontic patient according to claim 1 wherein the arch member has a generally rectangular cross-sectional configuration in at least one reference plane perpendicular to its longitudinal axis.

11. A brace for an orthodontic patient according to claim 1 wherein the arch member does not extend over the occlusal edges of the patient's teeth.

12. An orthodontic treatment system comprising:
a set of orthodontic appliances for connection to respective teeth of a patient's dental arch; and
a set of elongated arch members for removable coupling to at least some of the appliances, wherein at least one arch member has a geometry selected to move the teeth from a first arrangement to a second arrangement, and wherein at least one arch member has a geometry selected to move the teeth from the second arrangement to a third arrangement.

13. An orthodontic treatment system according to claim 12 wherein the first arrangement is an initial arrangement of the patient's teeth at the beginning of treatment.

14. An orthodontic treatment system according to claim 12 wherein the third arrangement is a final arrangement of the patient's teeth at the conclusion of treatment.

15. An orthodontic treatment system according to claim 12 wherein at least some of the arch members and at least some of the orthodontic appliances transmit light.

16. An orthodontic treatment system according to claim 12 wherein the arch members include at least one receptacle for receiving a corresponding appliance.

17. An orthodontic treatment system according to claim 12 wherein at least some of the arch members comprise a first component made of a certain material and a second component made of a certain material, and wherein the material of the first component has a rigidity that is greater than the rigidity of the material of the second component.

18. An orthodontic treatment system according to claim 12 wherein the arch members include receptacles, and wherein at least some of the receptacles of at least some of the arch members are elongated in directions along the length of the corresponding arch member.

19. An orthodontic treatment system according to claim 12 wherein at least one of the arch members comprises a shape memory polymeric material.

20. A brace for an orthodontic patient according to claim 12 wherein the arch member does not extend over the occlusal edges of the patient's teeth.

21. A brace for an orthodontic patient comprising:
a set of orthodontic appliances for connection to respective teeth of the patient's dental arch; and
an elongated arch member having a number of receptacles, wherein each receptacle receives a corresponding appliance, wherein the arch member comprises a first component of a first polymeric material and a second component of a second polymeric material, wherein the first component in connected to the second component, wherein the first component is remote from the receptacles and the second component is adjacent at least one receptacle, and wherein the first material has a rigidity that is greater than the rigidity of the second material.

22. A brace for an orthodontic patient according to claim 21 wherein the arch member has an overall shape that is adapted to move the teeth to predetermined, ideal positions.

23. A brace for an orthodontic patient according to claim 21 wherein at least some of the appliances and the arch member transmit light.

24. A brace for an orthodontic patient according to claim 21 wherein at least one receptacle is elongated in a direction generally along the longitudinal axis of the arch member in order to permit relative sliding movement between the arch member and the corresponding appliance.

25. A brace for an orthodontic patient according to claim 21 wherein the arch member includes a third component made of a third polymeric material, wherein the third component at least partially defines at least one receptacle and is connected to the second component, and wherein the second component is located between the first component and the third component.

26. A brace for an orthodontic patient according to claim 25 wherein the third component is made of a material that has a rigidity that is greater than the rigidity of the material of the second component.

27. A brace for an orthodontic patient according to claim 21 wherein at least some of the receptacles extend through the arch member.

28. A brace for an orthodontic patient according to claim 21 wherein the arch member has a cross-sectional configuration in reference planes perpendicular to its longitudinal axis that varies along its length.

29. A brace for an orthodontic patient according to claim 28 wherein the cross-sectional configuration is generally elliptical or oval in at least one reference plane along the longitudinal axis.

30. A brace for an orthodontic patient comprising:
a set of orthodontic appliances, each appliance connected to a tooth of the patient's dental arch; and
an elongated arch member having a number of receptacles, wherein each receptacle receives a corresponding appliance, and wherein at least one receptacle is elongated in a direction generally parallel to the longitudinal axis of the arch member to permit limited relative sliding movement of the appliance on the arch member.

31. A brace for an orthodontic patient according to claim 30 wherein at least some of the appliances and the arch member transmit light.

32. A brace for an orthodontic patient according to claim 30 wherein at least some of the receptacles extend through the arch member.

33. A brace for an orthodontic patient according to claim 30 wherein the arch member has a cross-sectional configuration in reference planes perpendicular to its longitudinal axis that varies along its length.

34. A brace for an orthodontic patient according to claim 33 wherein the cross-sectional configuration is generally elliptical or oval in at least one reference plane along the longitudinal axis.

35. A brace for an orthodontic patient according to claim 30, wherein the arch member is made of a polymeric material that has a glass transition temperature in the range of about 23° to about 37° C.

36. A brace for an orthodontic patient according to claim 30 wherein the arch member is made of a shape memory polymeric material.

37. A brace for an orthodontic patient according to claim 30 wherein the arch member does not extend over the occlusal edges of the patient's teeth.
